(19) United States
(12) Patent Application Publication
(10) Pub. No.: US 2006/0047849 A1
(43) Pub. Date: Mar. 2, 2006

(54) Apparatus and method for packet coalescing within interconnection network routers

(76) Inventor: Shubhendu S. Mukherjee, Framingham, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/881,845

(22) Filed: Jun. 30, 2004

(51) Int. Cl. G06F 15/173

(52) U.S. Cl. 709/238

(57) ABSTRACT

A method and apparatus for packet coalescing within interconnection network routers. In one embodiment, the method includes the scan of at least one input buffer to identify at least two network packets that include coherence protocol messages and are directed to the same destination, but from different sources. In one embodiment, coherence protocol messages within the network packets are combined into a coalesced network packet. Once combined, the coalesced network packet is transmitted to the same or matching destination. In one embodiment, combining multiple network packets (each containing a single logical coherence message) into a larger, coalesced network packet amortizes the fixed overhead of sending a network packet including a single coherence message, as compared to the larger, coalesced network packet, to improve bandwidth usage. Other embodiments are described and claimed.

### FIELD OF THE INVENTION

One or more embodiments of the invention relate generally to the field of integrated circuit and computer system design. More particularly, one or more of the embodiments of the invention relate to a method and apparatus for packet coalescing within interconnection network routers.

### BACKGROUND OF THE INVENTION

Cache-coherent shared-memory multi-processors with 16 or more processors have become common server machines. Revenue generated from the sales of such machines accounts for a growing percentage of the worldwide server revenue. This market segment's revenue has drastically increased during recent years, possibly making it the fastest growing segment of the entire server market. Hence, major venders offer such shared memory multi-processors, which scale up to anywhere between 24 and 512 processors.

High performance interconnection networks are critical to the success of large scale, shared-memory multi-processors. Such networks allow a large number of processors and memory modules to communicate with one another using a cache coherence protocol. In such systems, a processor's cache miss to a remote memory module (or another processor's cache) (“miss request”) and consequent miss response are encapsulated in network packets and delivered to the appropriate processors or memories. As described herein, miss requests and miss responses refer to coherency protocol messages.

The performance of many parallel applications, such as database servers, depend on how rapidly and how many of the coherency protocol messages can be processed by the system. Consequently, it is important for networks to deliver packets including coherency protocol messages with low latency and high bandwidth. However, network bandwidth can often be a precious resource and coherence protocols may not always use the bandwidth efficiently. In addition, networks typically have a certain amount of overhead to move a packet around the network.

The overhead required to move a packet around the network may include routing information and error correction information. For example, some shared memory multi-processors have as much as a 16% overhead to move a 64-byte payload. However, as the size of the packet payload increases, the overhead associated with moving the packet around the network decreases. Thus, for a shared memory multi-processor that requires a 16% overhead to move a 64-byte payload, such overhead would decrease to approximately 9% for network packets with 128-byte payload.

Unfortunately, network packets carrying coherence protocol messages are usually smaller because either they carry simple coherence information (e.g., an acknowledgement or request message); or small cache blocks (e.g., 64-bytes). Consequently, network packets including coherence protocols message typically use network bandwidth inefficiently, whereas more exotic, high performance coherency protocols can have far worse bandwidth utilization.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a processor, in accordance with one embodiment.

FIG. 2 is a block diagram illustrating a cache-coherence shared-memory multi-processor network, in accordance with one embodiment.

FIG. 3 is a block diagram further illustrating the interconnection router of FIG. 1, in accordance with one embodiment.

FIG. 4 is a block diagram further illustrating the interconnection router of FIG. 3, in accordance with one embodiment.

FIG. 5 is a block diagram illustrating one or more pipeline stages of the network router, as illustrated in FIGS. 3 and 4.

FIG. 6 is a block diagram illustrating a 2D mesh network for packet coalescing within interconnection routers, in accordance with one embodiment.

FIG. 7 is a flowchart illustrating a method for packet coalescing within interconnection routers, in accordance with one embodiment.

FIG. 8 is a flowchart illustrating a method for combining coherence protocol messages into a coalesced network packet, in accordance with one embodiment.

FIG. 9 is a flowchart illustrating a method for combining coherence protocol messages of identified network packets within a coalesced network packet, in accordance with one embodiment.

FIG. 10 is a block diagram illustrating various design representations or formats for simulation, emulation and fabrication of a design using the disclosed techniques.

### DETAILED DESCRIPTION

A method and apparatus for packet coalescing within interconnection network routers. In one embodiment, the method includes the scan of at least one input buffer to identify at least two network packets that include coherence protocol messages and are directed to the same destination, but from different sources. In one embodiment, coherence protocol messages within the network packets are combined into a coalesced network packet. Once combined, the coalesced network packet is transmitted to the same or matching destination. In one embodiment, combining multiple network packets (each containing a single logical coherence message) into a larger, coalesced network packet amortizes the fixed overhead of sending a network packet including a single coherence message, as compared to the larger, coalesced network packet, to improve bandwidth usage.

In the following description, certain terminology is used to describe features of the invention. For example, the term “logic” is representative of hardware and/or software configured to perform one or more functions. For instance, examples of “hardware” include, but are not limited or restricted to, an integrated circuit, a finite state machine or even combinatorial logic. The integrated circuit may take the form of a processor such as a microprocessor, application specific integrated circuit, a digital signal processor, a micro-controller, or the like.

An example of “software” includes executable code in the form of an application, an applet, a routine or even a series of instructions. In one embodiment, an article of manufacture may include a machine or computer-readable medium having software stored thereon, which may be used to program a computer (or other electronic devices) to perform a process according to one embodiment. The computer or machine readable medium includes, but is not limited to: a programmable electronic circuit, a semiconductor memory device inclusive of volatile memory (e.g., random access memory, etc.) and/or non-volatile memory (e.g., any type of read-only memory “ROM”, flash memory), a floppy diskette, an optical disk (e.g., compact disk or digital video disk “DVD”), a hard drive disk, tape or the like.

System

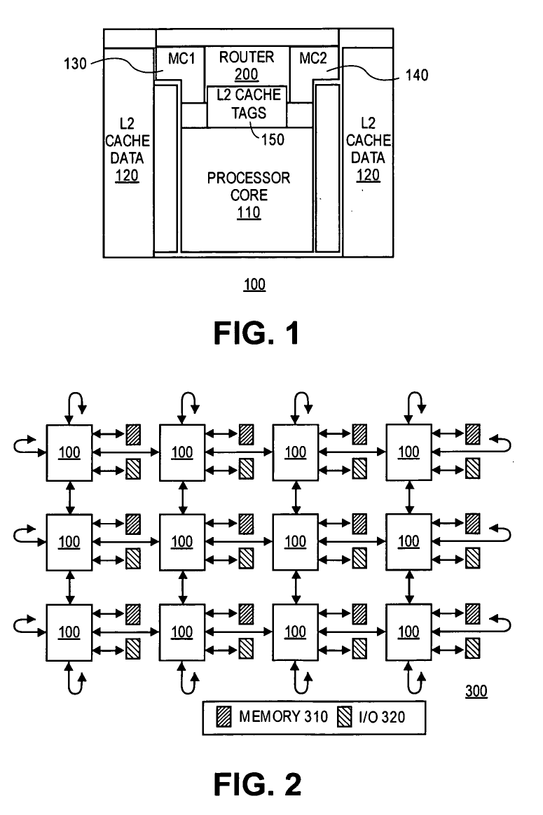

FIG. 1 is a block diagram illustrating processor 100, in accordance with one embodiment. Representatively, processor 100 integrates processor core 110, cache-coherence hardware (not shown), a first memory controller (MC) (MC1) 130, a second MC (MC2) 140, level two (L2) cache data including L2 cache tags 150 and interconnection router 200 on a single die. In one embodiment, processor 100 may be combined with a plurality of processors 100 and coupled together to form a shared-memory multi-processor network, in accordance with one embodiment. In one embodiment, a multi-processor network connects up to, for example, 128 processors 100 in a 2D torus network.

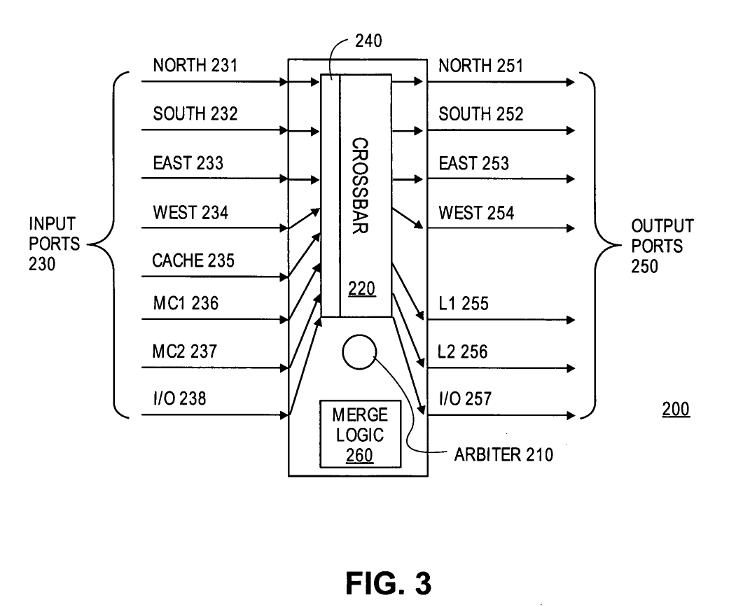

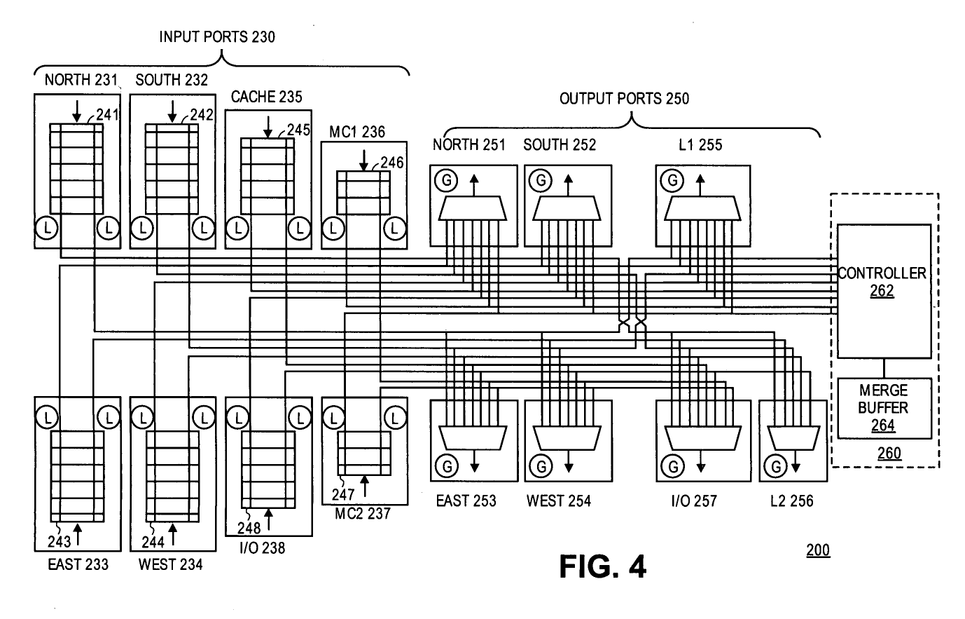

FIG. 2 illustrates a cache-coherent, shared-memory multi-processor system for a 12-processor configuration, in accordance with one embodiment. Although FIG. 2 illustrates a shared-memory multi-processor system including 12 multi-processors 100, those skilled in the art will recognize that the embodiments described herein apply to varying numbers of processors within a shared-memory multi-processor network. In one embodiment, interconnection router 200, as illustrated with reference to FIG. 3 and FIG. 4, may include a controller for combining multiple coherence protocol messages into a coalesced network packet to amortize the overhead of moving a packet within the multi-processor network 300.

As described herein, network packets and flits are the basic units of data transfer in multi-processor network 300. A packet is a message transported across the network from one router to another and consists of one or more flits. As described herein, a flit is a portion of a packet transported in parallel on a single clock edge. In one embodiment, a flit is 39 bits—32 bits for payload, 7 bits per flit error correction code (ECC). Representatively, each of the incoming and outgoing interprocessor ports shown in FIG. 2 may be 39 bits wide. However, other interprocessor port widths are possible while remaining within the embodiments described herein.

Multi-processor networks, such as multi-processor network 300, are generally optimized for transmission of packets having a largest supported packet size. In a network supporting a cache-coherent protocol, the largest packet size is typically used for carrying a 64- or 128-byte cache block. However, numerous short coherence protocol messages, such as requests, forwards and acknowledgements are transmitted within the network, resulting in the inefficient usage of network bandwidth. In one embodiment, multiple such short messages can be coalesced and sent in one bigger network packet, thereby taking advantage of the largest packet size for which the network is optimized.

FIG. 3 further illustrates interconnection router 200 of FIG. 1 including merge logic 260 to combine multiple network packets, each carrying different logical coherence messages into a single larger network packet within multi-processor network 300. In one embodiment this enables amortization of the overhead of moving a coherence message across network 300 to more effectively use available network bandwidth. In one embodiment, the number of packets that can be combined into one large network packet is dependent upon the implementation and is determined by the size of a cache block, network packet size, coherence read request size, coherence write request size and the like. The combining of multiple network packets, each including a different logical coherence message into a single larger network packet, is referred to herein as the “coalescing of coherence message”.

Referring again to FIG. 2, conventionally, packet flow-through multi-processor network 300 begins with a processor encountering a cache miss. The detection of the cache miss typically results in the queuing of a miss request in a miss address file (MAF). Subsequently, a controller converts the cache miss request into a network packet and injects the network packet into network 300. Network 300 delivers the packet to a destination processor whose memory typically processes the request and returns a cache miss response encapsulated in a network packet. The network delivers the response packet to the original requesting processor. As described herein, cache miss requests and cache miss responses are examples of coherence protocol messages.

As shown in FIG. 3, interconnection router 200 includes input ports 230 and input buffers 240 to route network packets to an output port 250, as determined by crossbar 220 and arbiter 210. Representatively, the north, south, east and west interprocessor input ports (231-234) and interprocessor output ports (251-254) (“2D torus ports”) correspond to off-chip connections to multi-processor network 300. MC1 and MC2 input ports (236 and 237) and output ports (255 and 256) are the two on-chip memory controllers MC1 130 and MC2 140 (FIG. 1). Cache input port 236 corresponds to L2 cache 120. L1 output port 255 connects to L1 cache and MC2 130 and L2 output port 256, L1 cache and MC2 140. In addition, I/O ports 238 and 257 connect to an I/O chip 320 external to multi-processor 100.

FIG. 4 further illustrates interconnection router 200 including merge logic 260, in accordance with one embodiment. Representatively, input ports 230 include associated input buffers 241-248. Router 200 typically queues-up the packets in buffers 241-248. These buffers can either be associated with an input port 230 or the buffers can comprise a shared central resource. In either case, arbiter 210 chooses packets from these buffers 241-248 and forward them to the appropriate output ports 250. As packets wait in input buffers 241-248, they provide a unique opportunity to be coalesced into a network packet referred to herein as a “coalesced network packet.” In an alternate embodiment, an output buffer, for example coupled to the output ports, is used to form coalesced network packets.

There are typically two sources of such coalescing available. First, two processors 100 often have a stable sharing pattern, such as a producer/consumer sharing pattern. Hence, a producer often sends packets to consumers in bursts. Such bursts of packets arrive at the same router and proceed to the same destination. However, the claimed subject matter is not limited to the preceding examples of bursts. In one embodiment, coherence protocol messages within packets from different source processors, but destined to the same processor, can be combined into a coalesced network packet and sent to a destination by merge logic 260.

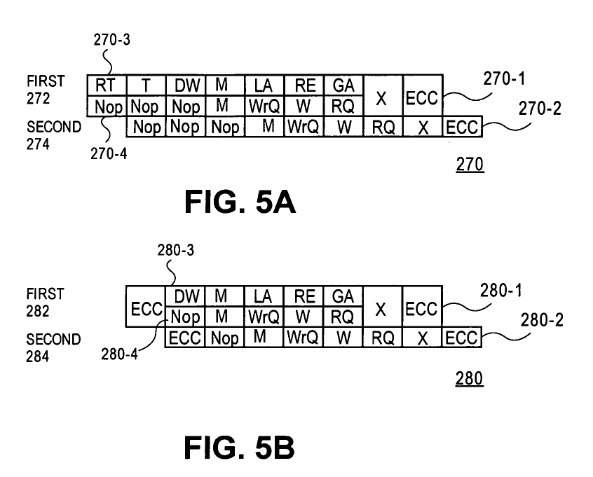

In one embodiment, merge logic 260 includes controller 262 to scan input buffers 240 of interconnection router 300 to detect network packets having a same destination that include a single coherence protocol message. In one embodiment, implementation of coherence message coalescing, as described herein, is performed by controller 262 using merge buffer 264. In one embodiment, an extra pipeline stage, referred to herein as the “merge pipeline stage” is added to the router pipelines, as illustrated in FIGS. 5A and 5B to provide coherence message coalescing.

In one embodiment, a merge buffer 264 is provided for each corresponding input buffer of interconnection router 300. In an alternate embodiment, a separate table of pointers is used to track network packets that have been identified for coalescing into a coalesced network packet. According to this embodiment, read logic is provided to follow the pointer chain to pick-up identified packets traversing through the pipeline of network router 300. In one embodiment, buffer entries within merger buffer 264 are pre-allocated to hold a largest packet size. According to such an embodiment, as packets are received, packets are merged together by dropping packets directly into the pre-allocated entries of merge buffer 264 that contain a network packet that is to be combined to form coalesced network packet.

TABLE 1

| | |
|---|---|
| DW | Decode and write entry table |
| ECC | Error correction code |
| GA | Global arbitration |
| LA | Local arbitration |
| M | Merge |
| Nop | No operation |
| RE | Read entry table and transport |
| RQ | Read input queue |
| RT | Router table lookup |
| T | Transport (wire delay) |
| W | Wait |
| WrQ | Write input queue |
| X | Crossbar |

As illustrated in FIGS. 5A and 5B, a router pipeline may consist of several stages that perform router table lookup, decoding, arbitration, forwarding via the crossbar and ECC calculations. A packet originating from the local port looks up its routing information from the router table and loads it up in its header. The decode stage decodes a packet's header information and writes the relevant information into an entry table, which contains the arbitration status of packets and is used in the subsequent arbitration pipeline stages. Table 1 defines the various acronyms used to describe the pipeline stages illustrated in FIGS. 5A and 5B.

FIG. 5A illustrates router pipeline 270 for a local input port (cache or memory controller) to an interprocessor output port. Conversely, FIG. 5B illustrates router pipeline 280 from an interprocessor (north, south, east or west) input port to an interprocessor output port. Representatively, the first flit (272/282) goes through two pipelines (270-1 and 280-1), one for scheduling (upper pipeline (270-3/280-3)) and another for data (lower pipeline (270-4/280-4)). Second flit (274/284) and subsequent flits follow the data pipeline (270-2/280-2). In one embodiment, a merge stage is added after the queuing stage for controller 262 to scan and combine packets including coherence protocol messages.

As illustrated, the merge pipeline stage (M) is added before write input queue (WrQ) pipeline stage. Accordingly, in one embodiment, after the decode stage (DW), controller 262 can detect a destination of a network packet. Subsequently, at merge stage (M), controller 262 can determine if the detected package can be merged with an existing packet. In one embodiment, tracking of a network packet with a coherence protocol message that can be combined with another network packet to form a coalesced network packet is performed by adding a pointer within, for example, a table of pointers to point to the detected packet. Subsequently, the coalesced network packet may be formed prior to transmission of the coalesced network packet to an output port.

As further illustrated in FIG. 4, arbiter 210 may include local arbitration logic (L), as well as global arbitration logic (G). In one embodiment, the arbitration pipeline consists of three stages: LA (input port arbitration), RE (Read Entry Table and Transport), and GA (output port arbitration) (see Table 1). The input port arbitration stage finds packets from input buffers 241-248 and nominates on of them for output port arbitration G. In one embodiment, each input buffer 240 has two read ports and each read port has an input port arbiter L associated with it.

In one embodiment, the input port arbiters L perform several readiness tests, such as determining if the targeted output port is free, using the information in the entry table. In one embodiment, the output port arbiters G accept packet nominations from the input port arbiters and decide which packets to dispatch. Each output port 250 has one arbiter. Once an output port arbiter G selects a packet for dispatch, it informs the input port arbiters L of its decision, so that the input port arbiters L can re-nominate the unselected packets in subsequent cycles.

In one embodiment, controller 262 scans for packets headed towards the same destination by accessing input buffers 240 via an additional read port. In the embodiment illustrated, controller 262 examines the multiple input buffers 240 to find packets from different sources that are headed to the same destination. In one embodiment, controller 262 includes a merge buffer 264, which may be used to store detected network packets including coherence protocol messages that are directed to a same destination, such as a multi-processor within, for example, network 300.

In one embodiment, formation of the coalesced network packet is performed prior to forwarding of the coalesced network packet to an output port 250 by crossbar 220. In one embodiment, network router 200 may include a shared resource input buffer. In accordance with such an embodiment, controller 262 searches the central buffer to detect network packets from different sources headed to a same destination. Once detected, controller 262 may identify network packets containing a single coherence protocol message to perform coalescing of the coherence protocol messages. Procedural methods for implementing one or more embodiments are now described.

Operation

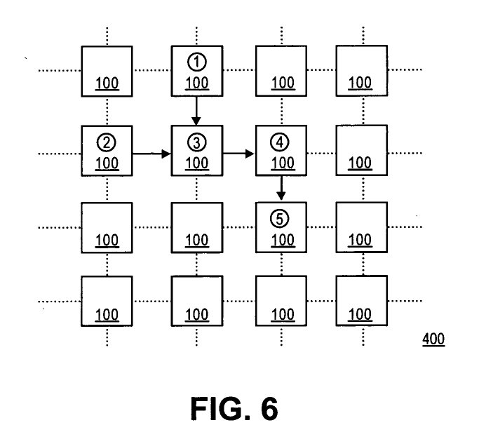

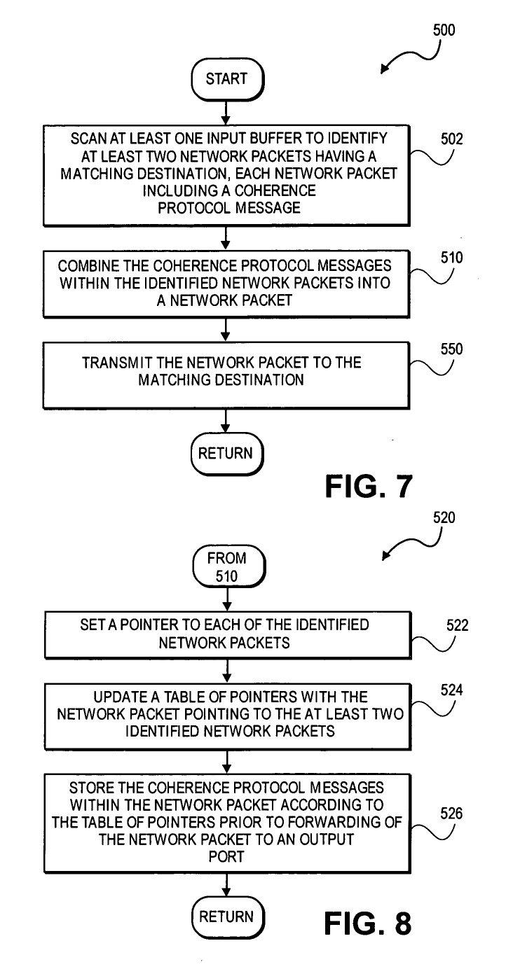

FIG. 7 is a flowchart illustrating a method 500 for packet coalescing within interconnection routers, in accordance with one embodiment, for example, as illustrated with reference to FIGS. 1-6. At process block 502, at least one input buffer is scanned to identify at least two network packets having a matching destination and including a coherence protocol message. Once detected, at process block 510, the coherence protocol messages within the identified network packets are combined to form a coalesced network packet. Once formed, the coalesced network packet is transmitted to the matching destination. For example, as illustrated with reference to FIG. 6, if two packets from sources 1 and 2 are destined to processor 5, the two packets could be combined in processor/router 3 l and then proceed as a larger combined network packet from 3 to 4 to 5.

FIG. 8 is a flowchart illustrating a method 520 for combining the coherence protocol messages within the identified network packets of process block 510 of FIG. 7, in accordance with one embodiment. At process block 522, a pointer is set to each of the identified network packets, for example, by controller 262, as illustrated in FIG. 4. At process block 524, a table of pointers is updated, such that the coalesced network packet points to the at least two identified network packets. At process block 526, the coherence protocol messages are stored within the coalesced network packet according to the table of pointers.

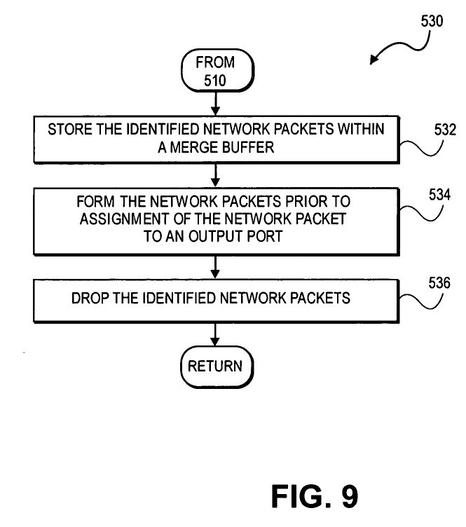

FIG. 9 is a flowchart illustrating a method 530 for combining the coherence protocol messages to form the coalesced network packet of process block 510 of FIG. 7, in accordance with one embodiment. At process block 532, the identified network packets of process block 502 are stored within a merge buffer, for example, as illustrated with reference to FIG. 4. At process block 534, a coalesced network packet is formed form the coherence protocol messages within the identified network packets prior to assignment of the coalesced network packet to an output port. At process block 536, the identified network packets are dropped.

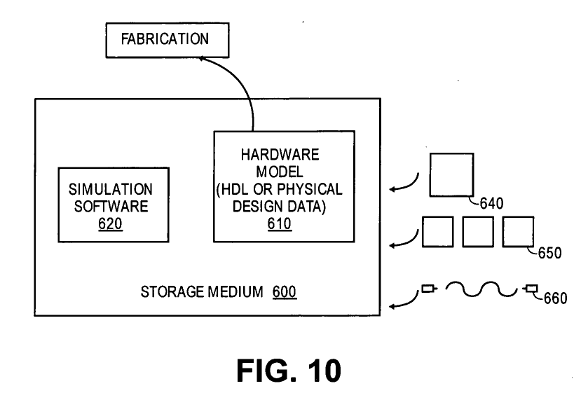

FIG. 10 is a block diagram illustrating various representations or formats for simulation, emulation and fabrication of a design using the disclosed techniques. Data representing a design may represent the design in a number of manners. First, as is useful in simulations, the hardware may be represented using a hardware description language, or another functional description language, which essentially provides a computerized model of how the designed hardware is expected to perform. The hardware model 610 may be stored in a storage medium 600, such as a computer memory, so that the model may be simulated using simulation software 620 that applies a particular test suite 630 to the hardware model to determine if it indeed functions as intended. In some embodiments, the simulation software is not recorded, captured or contained in the medium.

In any representation of the design, the data may be stored in any form of a machine readable medium. An optical or electrical wave 660 modulated or otherwise generated to transport such information, a memory 650 or a magnetic or optical storage 640, such as a disk, may be the machine readable medium. Any of these mediums may carry the design information. The term “carry” (e.g., a machine readable medium carrying information) thus covers information stored on a storage device or information encoded or modulated into or onto a carrier wave. The set of bits describing the design or a particular of the design are (when embodied in a machine readable medium, such as a carrier or storage medium) an article that may be sealed in and out of itself, or used by others for further design or fabrication.

Alternate Embodiments

It will be appreciated that, for other embodiments, a different system configuration may be used. For example, while the system 100 includes a shared memory multiprocessor system, other system configurations may benefit from the packet coalescing within interconnection network routers of various embodiments. Further different type of system or different type of computer system such as, for example, a server, a workstation, a desktop computer system, a gaming system, an embedded computer system, a blade server, etc., may be used for other embodiments.

Having disclosed embodiments and the best mode, modifications and variations may be made to the disclosed embodiments while remaining within the scope of the embodiments of the invention as defined by the following claims.

What is claimed is:

1. A method comprising:
scanning at least one input buffer to identify at least two network packets having a different source and a matching destination, each network packet including a single coherence protocol message;
combining the coherence protocol messages within the identified network packets into a coalesced network packet; and
transmitting the coalesced network packet to the matching destination.

2. The method of claim 1, wherein the network packets occur in a burst from a producer to a consumer according to a stable producer-consumer sharing pattern.

3. The method of claim 1, wherein the identified network packets are destined to the same processor.

4. The method of claim 1, wherein combining comprises:
setting a pointer to each of the identified network packets;
updating a table of pointers with the coalesced network packet pointing to the at least two identified network packets; and
storing the coherence protocol messages within the coalesced network packet according to the table of pointers prior to forwarding of the coalesced network packet to an output port.

5. The method of claim 1, further comprising:
dropping the identified network packets.

6. The method of claim 1, wherein scanning further comprises:
searching a central buffer to detect network packets from different sources headed to a same destination; and
identifying detected network packets containing a single coherence protocol message.

7. The method of claim 1, wherein combining further comprises:
storing the identified network packets within a merge buffer;
forming the coalesced network packet from the coherence protocol messages within the identified network packets prior to assignment of the coalesced network packet to an output port; and
dropping the identified network packets.

8. The method of claim 1, wherein scanning further comprises:
storing detected network packets including a single coherence protocol message within a merge buffer; and
scanning the merge buffer to identify the at least two network packets having the same destination.

9. The method of claim 1, wherein the combining of the coherence protocol messages within the identified network packets into the coalesced network packet is performed during a merge pipeline stage.

10. The method of claim 1, wherein a coherence protocol message within a network packet comprises one of a cache miss request and a cache miss response.

11. A method comprising:
storing detected network packets including a coherence protocol message within a merge buffer;
scanning the merge buffer to identify at least two network packets having a different source and a matching destination; and
forming a coalesced network packet from coherence protocol messages within the identified network packets.

12. The method of claim 11, wherein the coalesced network packet is formed prior to assignment of the coalesced network packet to an output port.

13. The method of claim 11, wherein forming the coalesced network packet comprises:
setting a pointer to each of the identified network packets;
updating a table of pointers with the coalesced network packet pointing to the at least two identified network packets; and
storing the coherence protocol messages within the coalesced network packet according to the table of pointers prior to forwarding of the coalesced network packet to an output port.

14. The method of claim 11, further comprising:
dropping the identified network packets.

15. The method of claim 11, wherein storing further comprises:
searching a central buffer to detect network packets containing a single coherence protocol message.

16. An apparatus, comprising:
at least one input buffer including a plurality of read ports; and
a controller to scan the at least one input buffer via a read port to identify at least two network packets having a different source and a matching destination, each network packet including a coherence protocol message, and to combine coherence protocol messages within the identified network packets into a coalesced network packet.

17. The apparatus of claim 16, wherein the at least one input buffer comprises:
a central buffer, the controller to search the central buffer via a read port to detect network packets from different sources headed to a same destination and to identify detected network packets containing a coherence protocol message.

18. The apparatus of claim 17, further comprising:
a merge buffer, the controller to store detected network packets including a coherence protocol message within the merge buffer and to scan the merge buffer to identify the at least two network packets having the different source and the matching destination.

19. The apparatus of claim 17, wherein the controller is to form the coalesced network packet prior to assignment of the coalesced network packet to an output port

20. The apparatus of claim 17, wherein the apparatus comprises an interconnection router of a chip multi-processor.

21. The apparatus of claim 17, further comprising:
a crossbar coupled to the at least one input buffer, the crossbar to forward the coalesced network packet to an output port.

22. The apparatus of claim 21, further comprising:
input port arbitration logic to nominate at least one network packet within the input buffer for output port arbitration; and
output port arbitration logic to accept packet nominations from the input port arbitration logic and to select a network packet for dispatch.

23. The apparatus of claim 16, wherein the controller is to combine the coherence protocol messages within the identified network packets into the coalesced network packet during a merge pipeline stage.

24. The apparatus of claim 21, further comprising:
four 2D torus input ports and four 2D torus output ports.

25. The apparatus of claim 16, wherein the apparatus further comprises:
a processor core coupled to the controller.

26. A system comprising:
a network including a plurality of processor nodes, each processor node including an interconnection router comprising:
at least one input buffer including a plurality of read ports, and
a controller to scan the at least one input buffer via a read port to identify at least two network packets having a different source and a matching destination, each identified network packet including a coherence protocol message and to combine coherence protocol messages within the identified network packets into a coalesced network packet.

27. The system of claim 26, wherein the system is a cache-coherent shared-memory multi-processor system.

28. The system of claim 26, wherein the network is a two-dimensional mesh network.

29. The system of claim 26, wherein the at least one input buffer comprises:
a central buffer, the controller to search the central buffer to detect network packets from different sources headed to a same destination and to identify detected network packets containing a coherence protocol message.

30. The system of claim 26, further comprising:
a merge buffer, the controller to store detected network packets including a coherence protocol message within the merge buffer and to scan the merge buffer to identify the at least two network packets having the same destination.
